(19) United States
(12) Patent Application Publication
(10) Pub. No.: US 2016/0173376 A1
(43) Pub. Date: Jun. 16, 2016

(54) INFORMATION PROCESSING APPARATUS, INFORMATION PROCESSING SYSTEM, AND COMPUTER-READABLE RECORDING MEDIUM HAVING STORED PROGRAM

(71) Applicant: FUJITSU LIMITED, Kawasaki-shi (JP)

(72) Inventor: Nobuyuki Shichino, Kahoku (JP)

(73) Assignee: FUJITSU LIMITED, Kawasaki-shi (JP)

(21) Appl. No.: 14/951,958

(22) Filed: Nov. 25, 2015

(30) Foreign Application Priority Data
Dec. 10, 2014 (JP) 2014-249558

(51) Int. Cl. H04L 12/741

(52) U.S. Cl. CPC H04L 45/74; H04W 88/16

(57) ABSTRACT

An information processing apparatus is connectable to an external network (NW), and includes units including a loopback device (LDB) that conducts an inter-process communication in the OS; an external NW interface (NI) provided in at least one unit and connected to the external NW; and an internal NI provided in each unit and connected to an internal NW established by a second address system independent from a first address system of the external NW connected to the external NI. Each internal NI conducts inter-unit communications using the second address system. Each LDB driver includes a determining unit that determines whether a packet to be processed is addressed to a local unit or to a remote unit, and a guiding unit that guides the packet to be processed by the OS to a processing in accordance with a result of determination, thereby enabling an internal NW unaffected by an external NW.

### CROSS-REFERENCE TO RELATED APPLICATIONS

This application is based upon and claims the benefit of priority of the prior Japanese Application No. 2014-249558 filed on Dec. 10, 2014 in Japan, the entire contents of which are hereby incorporated by reference.

### FIELD

The embodiments discussed herein are directed to an information processing apparatus, an information processing system, and a computer-readable recording medium having stored a program.

### BACKGROUND

In general, an information processing apparatus which includes a server apparatus and a storage apparatus is improved in maintenance and availability (verbosity) by dividing various internal functions into a plurality of units.

When Ethernet® is introduced between the plurality of units for the cooperation between the plurality of units which are divided as described above, the information processing apparatus can use various application software which utilizes Ethernet. Therefore, it is possible to improve productivity of the information processing apparatus.

However, in a case where Ethernet is introduced as an internal network, it is advisable that the address system of Ethernet is established without contradiction (conflict) to the address system of an external network which is linked to the information processing apparatus. For this reason, a process of changing the address system of the internal network in cooperation with the address setting and address change of the external network is implemented. In this way, during a period while the process of changing the address system of the internal network, it is difficult to keeping the cooperation between the units.

Herein, an example of a conflict between the address system of the internal network and the address system of the external network will be described with reference to FIG. 17.

In the example illustrated in FIG. 17, a terminal 400 is communicably connected to an information processing apparatus 100 through an external network 200 and a gateway 300. Further, the information processing apparatus 100, for example, includes five units 101 to 105. These units 101 to 105 are communicably connected through an internal network 106.

Herein, the external network 200 is Ethernet which is managed by a user who uses the information processing apparatus 100. The information processing apparatus 100 is an interface which provides an Ethernet service.

Further, the internal network 106 of the information processing apparatus 100 is Ethernet which connects the units 101 to 105 in the information processing apparatus 100. The units 101 to 105 cooperate to each other through the internal network 106.

The respective units 101 to 105 are components included in the information processing apparatus 100, and divided according to certain functions in order to improve maintenance and availability (verbosity) of the information processing apparatus 100. In each unit 101 to 105, a general-purpose OS is loaded to use Ethernet applications. Then, the unit 101 includes an external network interface 110 which is connected to the external network 200 and conducts a communication with the external terminal 400. Further, the unit 101 includes an internal network interface 111 which is connected to the internal network 106 and conducts a communication with the other units 102 to 105. Similarly, the units 102 to 105 include internal network interfaces 121 to 151, respectively, which are connected to the internal network 106 and conduct communication with the unit 101. In addition, the units 101 to 105 may be denoted by Units #1 to #5, respectively.

At this time, the Internet Protocol (IP) address 192.168.1.1 for the external network 200 is assigned to the information processing apparatus 100 (the external network interface 110). Further, the IP address 172.16.0.10 is assigned to the terminal 400. Then, the IP addresses 172.16.0.1 to 172.16.0.5 for the internal network 106 are assigned to the units 101 to 105 (the internal network interfaces 111 to 151) in the information processing apparatus 100, respectively.

In a case where the IP addresses are assigned as described above, the unit 101 loses its ability to conduct communication with the external terminal 400. This is because the IP address of the terminal 400 is 172.16.0.10 and belongs to the address system of the internal network 106 of the information processing apparatus 100. In this case, even when the unit 101 tries to conduct communication with the terminal 400, a packet addressed to the terminal 400 flows into the internal network 106.

Therefore, as illustrated in FIG. 17, in a case where the address used in the outside of the information processing apparatus 100 comes into conflict with the address system used in the information processing apparatus 100, the process of changing the address system of the internal network, as described above, is performed in cooperation with the address of the external network.

As described above, when the process of changing the address system of the internal network in cooperation with the address of the external network is occurred, there is a problem in that it is difficult to keep the cooperation between the units during a period when the process is performed.

Patent Document 1: Japanese Laid-open Patent Publication No. 2010-49676

Patent Document 2: Japanese Laid-open Patent Publication No. 2009-151744

### SUMMARY

An information processing apparatus according to the present application is connectable to an external network, and includes a plurality of units, an external network interface, and an internal network interface. Each of the plurality of units includes an operating system (OS) and a loopback device that conducts an inter-process communication in the OS. The external network interface is provided in at least one of the plurality of units and is connected to the external network. The internal network interface is provided in each of the plurality of units and is connected to an internal network which is established by a second address system independent from a first address system of the external network connected to the external network interface. An address system in the inter-process communication conducted by the loopback device is used as the second address system. The internal network interface of each of the plurality of units conducts a communication between the plurality of units using the second address system. Each loopback device driver further includes a determining unit and a guiding unit. The determining unit determines whether a packet to be processed by the OS is addressed to a local unit or to a remote unit. The guiding unit guides the packet to be processed to a processing in accordance with a result of determination by the determining unit.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF THE DRAWINGS

FIG. 1 is a block diagram illustrating a hardware configuration and a functional configuration of an information processing system which includes an information processing apparatus according to the embodiment;

FIG. 2 is a block diagram illustrating a hardware configuration and a functional configuration of each unit which is included in the information processing apparatus illustrated in FIG. 1;

FIGS. 3 and 4 are diagrams for describing inter-process communication of a loopback device;

FIGS. 5 to 11 are diagrams for describing communication operations between the units in a comparative example of the present embodiment;

FIG. 12 is a diagram for describing an overview of processing in accordance with the present embodiment;

FIG. 13 is a flowchart for describing a procedure for communications between the units according to the embodiment (operations of a loopback device driver);

FIGS. 14 to 16 are diagrams for describing the communication operation between the units according to the embodiment; and

FIG. 17 is a diagram illustrating an example of a conflict between the address system of an internal network and the address system of an external network.

### DESCRIPTION OF THE PREFERRED EMBODIMENTS

Hereinafter, embodiments of an information processing apparatus, an information processing system, and a computer-readable recording medium having a program stored thereon disclosed in the present application will be described in detail with reference to the drawings. However, the following embodiments are given as merely exemplary, and it is not intended to exclude various modifications and various technical applications which are not specified in the embodiments. In other words, the embodiments can be implemented in various forms within a scope not departing from the spirit thereof. Further, there is no purpose of exclusively including only the components in the drawings, but other functions can be included. Then, the respective embodiments can be implemented by appropriately combining each other in a scope where the processing contents are not contradicted.

### [1] Configurations of Information Processing System Having Information Processing Apparatus of Embodiment

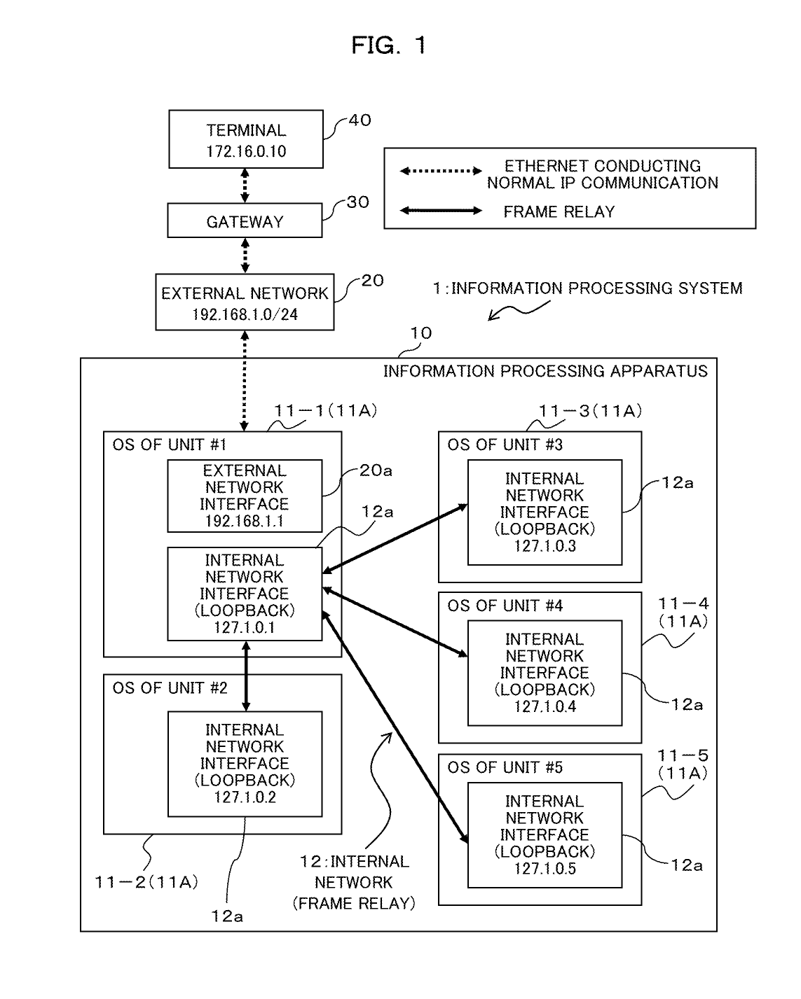

First, a hardware configuration and a functional configuration of an information processing system 1 which includes an information processing apparatus 10 according to the embodiment will be described with reference to FIG. 1. In addition, FIG. 1 is a block diagram illustrating the hardware configuration and the functional configuration.

In the information processing system 1 illustrated in FIG. 1, a terminal (external unit) 40 is communicably connected to the information processing apparatus 10 through an external network 20 and a gateway 30. Further, the information processing apparatus 10, for example, includes five units 11-1 to 11-5, and these units 11-1 to 11-5 are communicably connected to one another through an internal network 12. In addition, as a symbol for indicating a unit, when there is a need to specify one of a plurality of units, the symbols 11-1 to 11-5 will be used, and when any unit is indicated, the symbol 11 will be used. Further, the information processing apparatus 10, for example, is assumed to include a server apparatus, a unified storage device, and the like.

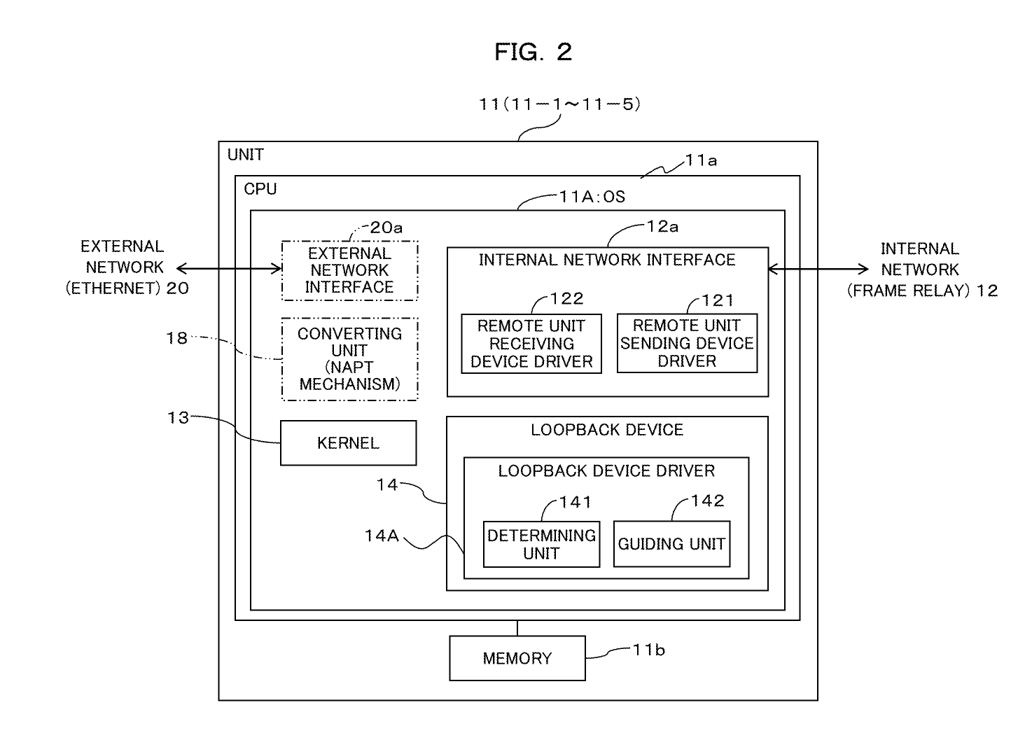

The information processing apparatus 10 of the embodiment is connectable to the external network 20, and as to be described below includes at least the plurality of units 11, an external network interface 20a, and an internal network interface 12a. The external network interface 20a is provided in at least one unit 11-1 of the plurality of units 11, and is connected to the external network 20. Further, the internal network interface 12a is provided in each unit 11, and connected to the internal network 12 which is established by a second address system independent from a first address system of the external network 20 connected to the external network interface 20a. Then, the internal network interface 12a of each unit 11 conducts a communication between the plurality of units 11 using the second address system. Note that the internal network interface 12a may be embodied by a communication application program on a generic OS 11A (see FIG. 2), which will be described later.

Herein, the external network 20 is Ethernet which is managed by a user who uses the information processing apparatus 10. The information processing apparatus 10 is an interface which provides an Ethernet service.

Further, the internal network 12 of the information processing apparatus 10 is Ethernet which connects the units 11 in the information processing apparatus 10. The units 11 cooperate with each other through the internal network 12.

The respective units 11 are components included in the information processing apparatus 10, and various functions are divided and assigned to the units in the information processing apparatus 10. Therefore, maintenance and availability (verbosity) are improved by dividing such functions and assigning them to the plurality of units 11. On each unit 11, a general-purpose OS 11A is loaded in order to use an Ethernet application. Further, each unit 11 virtually includes a loopback device 14 (see FIG. 2) which conducts a communication between processes (applications) in the OS 11A. The loopback device 14 also includes a loopback device driver 14A (see FIG. 2) that controls the loopback device 14.

The unit 11-1 which is one of the plurality of units 11 includes the external network interface 20a which is connected to the external network 200 and conducts a communication with the terminal (external Step) 40. Further, the unit 11-1 includes the internal network interface 12a which is connected to the internal network 12 and conducts a communication with the other units 11-2 to 11-5. Similarly, each unit 11-2 to 11-5 includes the internal network interface 12a which is connected to the internal network 12 and conducts a communication with the unit 11. In addition, the units 11-1 to 11-5 may be denoted as Units #1 to #5, respectively.

At this time, in the information processing system 1 according to the embodiment, the second address system independent from the first address system (192.168.1.0/24) of the external network 20 is established in the internal network 12. Therefore, in the embodiment, the address system of inter-process communication conducted by the loopback device 14 is used as the second address system.

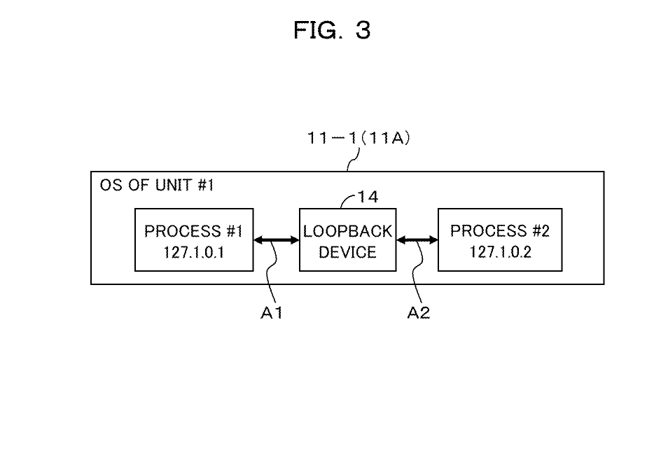

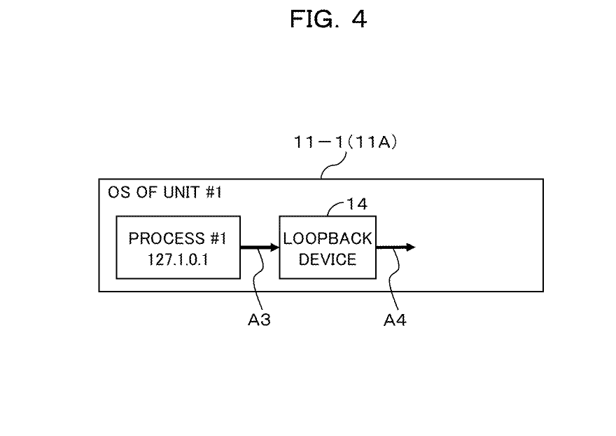

A packet flowing to the loopback device 14 does not flow out of the OS 11A which uses the packet due to the characteristics of the loopback device 14. For example, as illustrated in FIG. 3, the packet is used for the cooperation between two Processes #1 and #2 in one OS 11A (see arrows A1 and A2 of FIG. 3). FIG. 3 illustrates an example of conducting inter-process communication on the unit 11-1, and Processes #1 and #2 are assigned with addresses 127.1.0.1 and 127.1.0.2, respectively. Further, as illustrated in FIG. 4, the packet addressed to the loopback device 14 can be transmitted even when there is no transmission destination (see arrows A3 and A4 of FIG. 4). In other words, it is possible to transmit the packet without causing an error even when there is no transmission destination. In this case, the packet having no transmission destination will be discarded after being transmitted to the loopback device 14. In addition, FIGS. 3 and 4 are diagrams for describing the inter-process communication conducted by the loopback device 14.

The address system in the inter-process communication conducted by the loopback device 14 is 127.0.0.0/8, and it is possible to secure about 16.77 million addresses. In the embodiment, IP addresses on the loopback device 14 are assigned not to cause conflicts in the units 11-1 to 11-5 which are included in the information processing apparatus 10. For example, in FIG. 1, addresses 127.1.0.1 to 127.1.0.5 of the address system for looping back are assigned to the units 11-1 to 11-5 as the IP addresses.

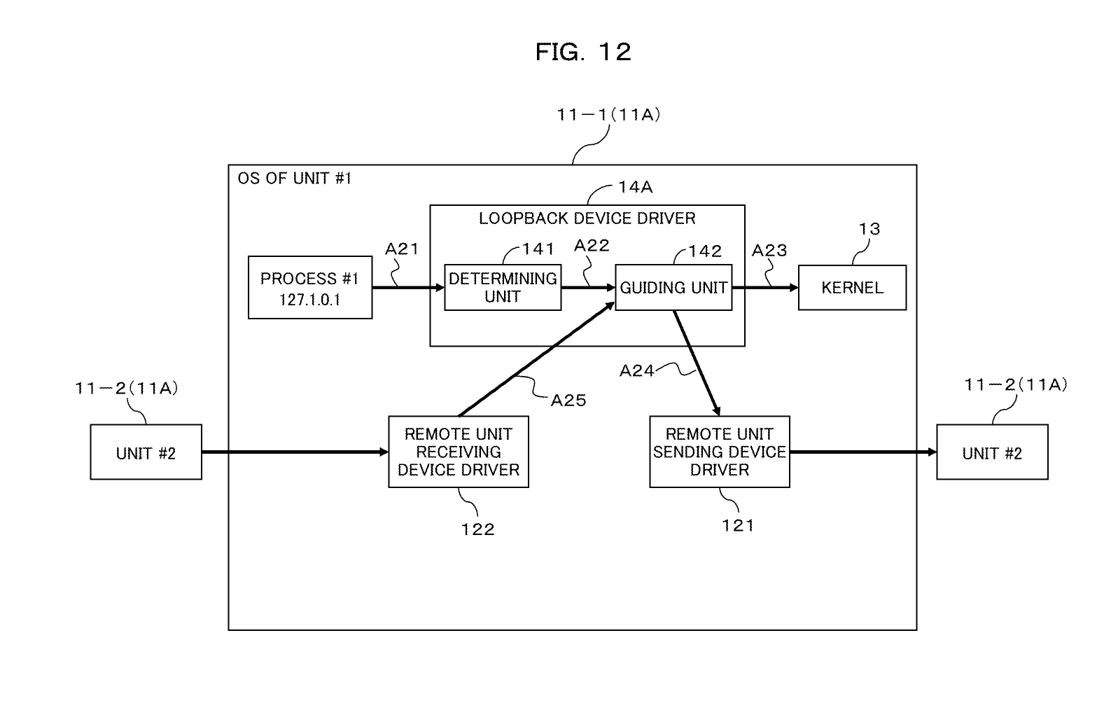

Therefore, the internal network interface 12a is established by the second address system independent from the first address system of the external network 20, and conducts a communication between the units 11 using the address system in the inter-process communication conducted by the loopback device 14. In this case, as described above, the packet flowing to the loopback device 14 does not flow out of the OS 11A which uses the packet due to the characteristics of the loopback device 14. In the embodiment, as to be described below with reference to FIGS. 12 to 16, an IP network using the loopback device 14 is established by using the functional configuration of each unit 11 which will be described with reference to FIG. 2.

In addition, the second address system (IP addresses of the respective units 11) may be manually set to each unit 11 by a system manager, or may be that is automatically set by software such as an OS. For example, the firmware of each unit 11 automatically generates and sets its own address based on location information (slot number) of the hardware. Further, as another example, a dynamic host configuration protocol (DHCP) function is included in the OS 11A of Unit #1 or a control unit such as a CPU 11a to automatically deliver setting information to the other units 11, so that each unit 11 may receive the setting information for its own setting. According to the DHCP function, the connection can be immediately performed using appropriate setting even though the network setting is not made manually. Therefore, a user who does not have enough knowledge of the network setting can simply make connection.

As the internal network 12 for communicably connecting the units 11, for example, a general-purpose communication line which is not for the IP communication is used. Further, as the general-purpose communication line, for example, a frame relay communication line (such as a serial line and Ethernet using no IP) can be used. In the example illustrated in FIG. 1, the frame relay communication line is used as the internal network 12. Therefore, the internal network interface 12a of each unit 11 has functions as a frame relay transmission unit and a frame relay reception unit. With the use of relays and the like in the unit 11, it is possible to establish a network environment which enables frame relaying between arbitrary units 11.

In addition, a shared memory (not illustrated) may be provided as the internal network 12 between the plurality of units 11 instead of the general-purpose communication line. Therefore, the communication may be conducted between the units 11 through the shared memory.

Further, in the information processing system 1 illustrated in FIG. 1, the IP address 192.168.1.1 for the external network 20 is assigned to the information processing apparatus 10 (the external network interface 20a), and the IP address 172.16.0.10 is assigned to the terminal 40.

Furthermore, the plurality of units 11 serving as various divided functions of the information processing apparatus 10 may be physically independent from each other, and communicably connected to each other through the internal network 12. Further, some of the plurality of units 11 serving as various divided functions of the information processing apparatus 10 may be a plurality of virtual machines (not illustrated) which are established on a hypervisor (virtualized OS; not illustrated) executed by the CPU 11a of each unit 11 (see FIG. 2). Different types of OSs 11A are operated in parallel on the plurality of virtual machines (the units 11).

As an example of making the plurality of OSs 11A operate on the hypervisor in one CPU 11a, there is a unified storage device. In the unified storage device, for example, a storage area network (SAN) OS and a network attached storage (NAS) OS are operated on the hypervisor. As the SAN OS, for example, VxWorks® made by Wind River is used, and as the NAS OS, for example, Linux® is used.

In such a unified storage device, the unit (virtual machine) 11 which operates the SAN OS can conduct communication using the internal network interface 12a with other units 11 outside the CPU 11a through the internal network 12. Although the unit (virtual machine) 11 which operates the NAS OS can conduct communication with the unit 11 which is mounted on the same hypervisor as the NAS OS and operates the SAN OS, it is generally not allowed to conduct communication with other units 11 which are outside the CPU 11a and not directly connected to the NAS OS.

### [2] Comparative Example of Embodiment and Overview of Embodiment

### [2-1] Comparative Example of Embodiment

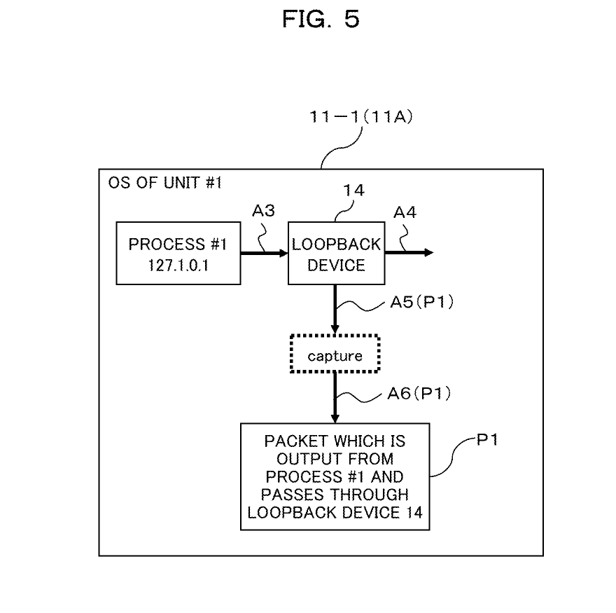

First, referring to FIGS. 5 to 11, one specific example for realizing communications between the units in the above-described information processing system 1 will be described, as a comparative example of the present embodiment. FIGS. 5 to 11 are diagrams for describing communication operations between the units in a comparative example of the present embodiment. In FIGS. 5 to 11, the communication operation between the unit #1 and the unit #2 is described in which only the main components in the unit 11 are illustrated. As described above, the IP addresses 127.1.0.1 and 127.1.0.2 of the address system in the inter-process communication conducted by the loopback device 14 are assigned to the units #1 and #2, respectively. In addition, in the drawings, the same symbols as those described above indicate the identical or similar portions, and thus the descriptions thereof will not be repeated.

First, referring to FIGS. 5 to 7, the basic communication procedure between the units in the comparative example will be described.

In a case where the communication is conducted between the unit #1 and the unit #2, Process (Process at the transmission source) #1 of the unit #1 at the transmission source generates a packet to Process (Process at the transmission destination) #2 of the unit #2 at the transmission destination and outputs the packet to the loopback device 14 (see arrows A3 and A4 of FIG. 5).

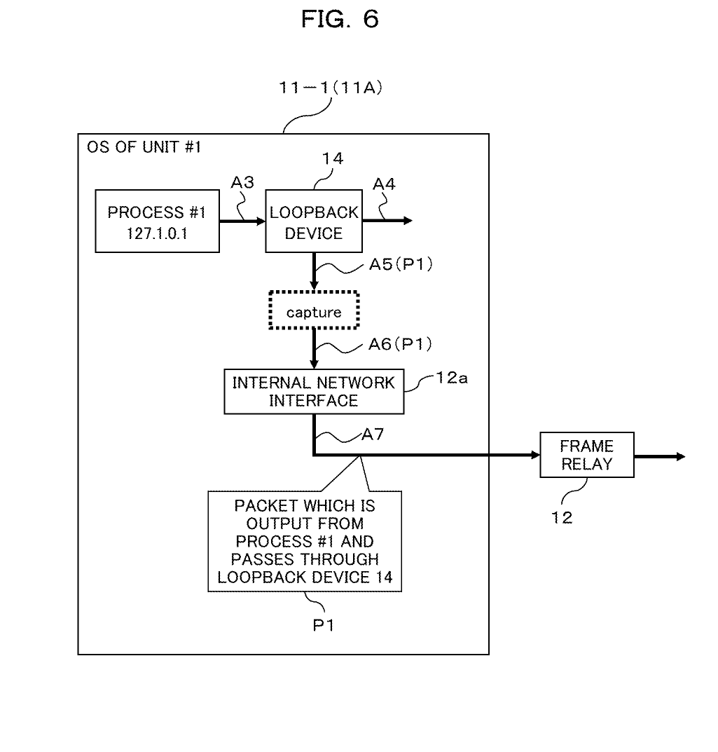

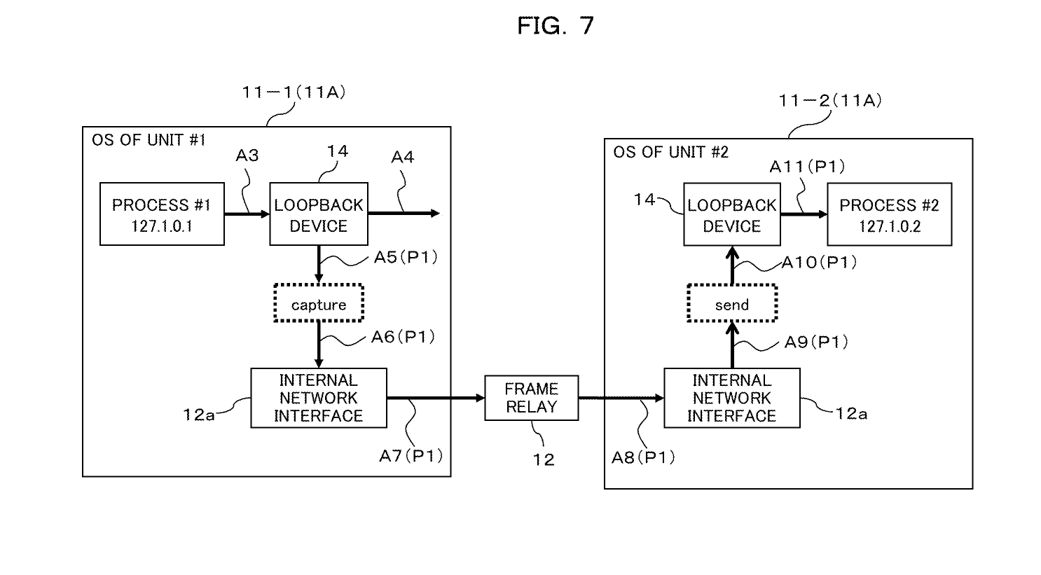

At this time, using the capturing (capture) function originally provided in the OS 11A, a packet capture is provided on the loopback device 14, and the packet P1 addressed to Process #2 at the transmission destination is extracted (see arrows A5 and A6 of FIG. 5). The extracted packet P1 is output to an appropriate frame relay 12 according to the IP address of Process #2 at the transmission destination using a function as the frame relay transmission unit of the internal network interface 12a (see Arrow A7 of FIGS. 6 and 7). As a result, the packet P1 is transmitted to the unit #2 at the transmission destination. The capturing function is to capture a packet in order to monitor a network status. The internal network interface 12a outputs the packet P1 captured by the capturing unit 15 to the internal network 12, and transmits the packet to the unit 11 at the transmission destination according to the address system in the inter-process communication conducted by the loopback device 14.

The packet P1 transmitted by the frame relay 12 is received using a function as the frame relay reception unit of the internal network interface 12a of the unit #2 at the transmission destination (see Arrow A8 of FIG. 7). The internal network interface 12a which has received the packet P1 determines whether the packet P1 is addressed to its own unit (local unit) #2.

In a case where the received packet P1 is addressed to the local unit #2, the internal network interface 12a transfers the packet P1 to the sending (send) function (see Arrow A9 of FIG. 7). Then, the send function sends the packet P1 to Process #2 at the transmission destination through the loopback device 14 (see arrows A10 and A11 of FIG. 7). The sending (send) function is originally provided in the OS 11A, and is to send the packet (P1 or P2) addressed to the local unit received by the internal network interface 12a to the process (Process #2 or #1) at the transmission destination through the loopback device 14.

Otherwise, in a case where the packet P1 is not addressed to the local unit #2, the internal network interface 12a transfers the packet P1 to another OS 11A (another unit 11; remote unit 11) on the hypervisor on which the OS 11A of the local unit #2 is established. In addition, also the packet transmission from the unit #2 (Process #2) to the unit #1 (Process #1) is performed according to the same procedure as described above. As a result, the communication is realized between the unit #1 and the unit #2.

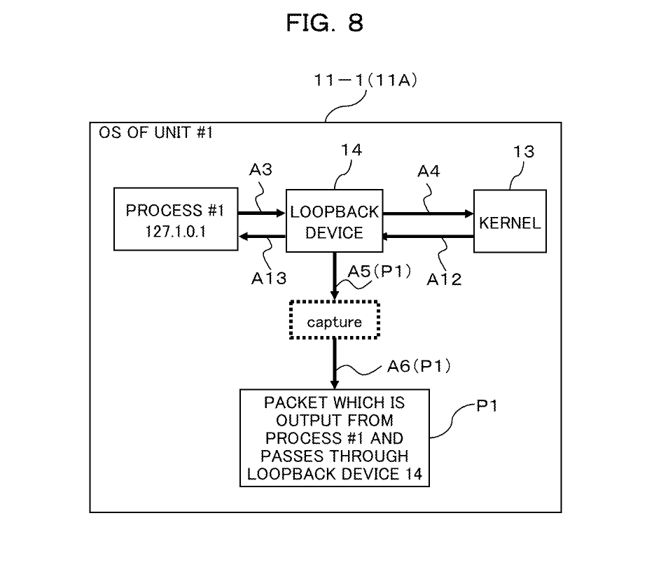

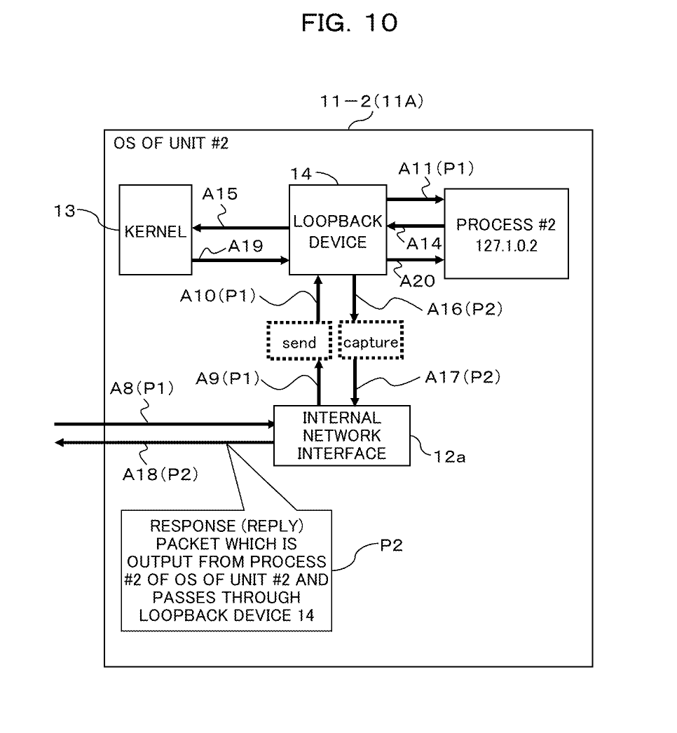

Hitherto, the description has been made about the basic communication procedure between the units in the comparative example of the present embodiment. However, in a case where transmission control protocol (TCP) communication is conducted, the communication between the units may not be allowed depending on types of OSs as illustrated in FIGS. 8 and 10. For example, in FIG. 4, the packet transmitted from Process #1 is illustrated to disappear after passing through the loopback device 14. However, depending on the types of OSs (for example, Linux), the packet which has passed through the loopback device 14 may be received by the kernel 13 (see Arrow A4 of FIG. 8). When receiving such a packet, the kernel 13 considers the communication by the packet as the TCP communication for a non-existent service (Process #2), and replies to Process #1 at the transmission source with a communication end signal, that is, a TCP reset signal (RST) (see arrows A12 and A13 of FIG. 8). By the reset signal, the connection of the TCP communication is cut off, and the communication relating to the packet P1 from Process #1 at the transmission source is stopped. Therefore, as illustrated in FIGS. 5 to 7, even when there is a reply to the captured packet P1 from the unit #2 at the transmission destination, it is not possible to handle the reply, and thus the communication between the units is ended without being established. The kernel 13 is software which provides basic functions as the OS such as monitoring application software and peripheral devices, managing resources such as disks and memories, an interrupt process, and the inter-process communication.

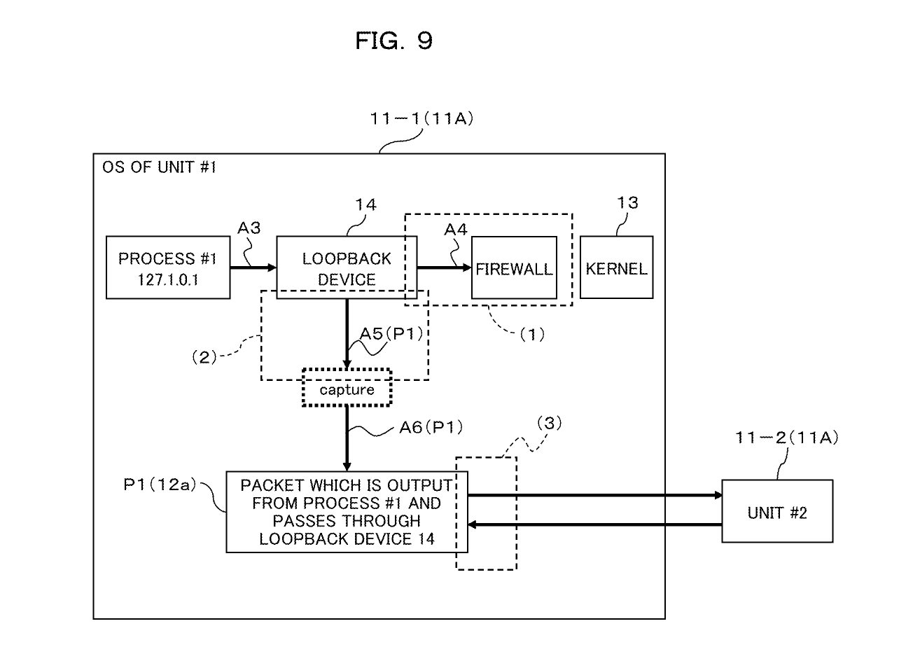

In order to suppress the situation which occurs in the unit #1 at the transmission source as described above, in the comparative example depicted in FIG. 9, a technique is employed wherein the packet P1 which is addressed to the unit #2 at the transmission destination and has passed through the loopback device 14 is blocked and discarded by the firewall function before the packet is transferred to the kernel 13 (see Arrow A4 of FIG. 9). Therefore, since the kernel 13 does not receive the packet P1, the reset signal is not replied from the kernel 13 to Process #1 at the transmission source, and thus it is possible to suppress that the communication between the units is ended without being established.

Further, in a case where an existing service (Process #2) is present in the unit #1 at the transmission source, the service (Process #2) in its own OS 11A replies instead of the service (Process #2) of the other unit #2. In other words, in a case where there is no special action, all the packets addressed to the units within a loopback address range are received in the unit #1 at the transmission source. For example, in FIG. 7, the packet P1 is transmitted to the unit at the address 127.1.0.2. However, since the address belongs to the loopback address range, the packet P1 comes to be received by the service in the OS 11A of the unit #1 which makes a reply. Even such a situation is solved since the firewall serving as the firewall function is set to discard the packet addressed to the unit at the address 127.1.0.2.

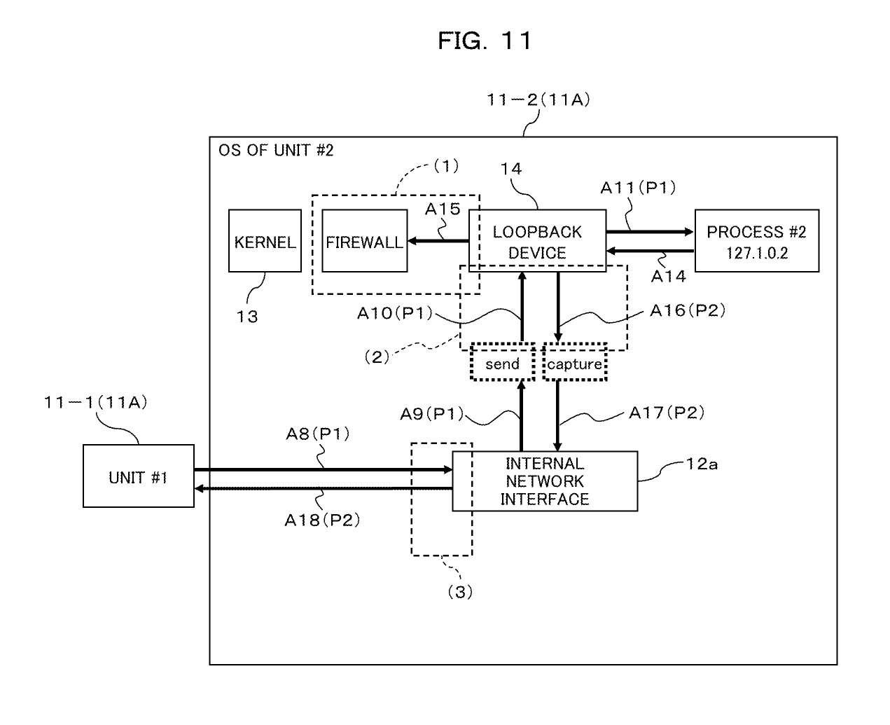

In addition, in FIGS. 8 and 9, the description has been made about the unit #1 at the transmission source, but as illustrated in FIGS. 10 and 11, even a disadvantage caused by the reset signal of the kernel 13 in the unit #2 at the transmission destination is solved using the firewall function. In other words, as illustrated in FIG. 10, Process #2 at the transmission destination which has received the packet P1 generates the response packet (reply packet) P2 to Process #1 at the transmission source and outputs the packet to the loopback device 14 (see Arrow A14 of FIG. 10). The response packet P2 which passes through the loopback device 14 is extracted by the capturing function (see arrows A16 and A17 of FIG. 10). The extracted response packet P2 is output to an appropriate frame relay 12 by the function as the frame relay of the internal network interface 12a (see Arrow A18 of FIG. 10). Therefore, the response packet P2 is transmitted to the unit #1 at the transmission source.

At this time, the response packet P2 which has passed through the loopback device 14 may be received by the kernel 13 (see Arrow A15 of FIG. 10). When receiving the response packet P2, the kernel 13 considers the communication by the packet P2 as the TCP communication for a non-existent service (Process #1), and replies to Process #2 with the TCP reset signal (see arrows A19 and A20 of FIG. 10). By the reset signal, the connection of the TCP communication is cut off, and the communication relating to the response packet P2 from Process #2 is stopped. Therefore, even when there is a reply to the response packet P2 from the unit #1 at the transmission source, it is not possible to handle the reply, and thus the communication between the units is ended without being established.

In order to suppress the situation which occurs in the unit #2 at the transmission destination as described above, in the comparative example depicted in FIG. 11, a technique is employed wherein the response packet P2 which is addressed to the unit #1 at the transmission source and has passed through the loopback device 14 is blocked and discarded by the firewall function before the packet is transferred to the kernel 13 (see Arrow A15 of FIG. 11). Therefore, since the kernel 13 does not receive the response packet P2, the reset signal is not replied from the kernel 13 to Process #2, and thus it is possible to suppress that the communication between the units is ended without being established.

In the meantime, the capturing function in the comparative example described above with reference to FIGS. 5 to 11, may be embodied as software in a user space in the OS layer. A capturing function supported by a typical OS, however, is to perform processing merely to copy packets (P1 and P2). Thus, the source packet would undergo the same processing, regardless of whether a capture is carried out by the capturing function. For that reason, the firewall function is used in the comparative example, as described above. Since the capturing function used in the comparative example is software in the user space, upon carrying out capturing, a processing for copying a packet from the kernel space to the user space takes place.

Further, sending a captured packet to a remote unit generally involves a hardware operation. Thus, the packet passes through a remote unit sending device driver (see Symbol 121 in FIG. 2) that is being executed in the kernel space. In this case, a processing for copying the packet from the user space to the kernel space to takes place, in the direction opposite to the direction of the capturing.

In other words, in the comparative example described above with reference to FIGS. 5 to 11, the following drawbacks (i) through (iii) may arise:

(i) Although a packet to be captured will be processed in a remote unit and thus the local unit does not have to carry out any processing on it, that packet underdoes a processing in the local unit. For this reason, the packet is blocked and discarded using a firewall function, in the comparative example. Thus, an additional processing for discarding that packet takes place (see the region indicated by Symbol (1) in FIGS. 9 and 11).

(ii) Upon carrying out capturing, the processing for copying the packet from the kernel space to the user space takes place (see the region indicated by Symbol (2) in FIGS. 9 and 11).

(iii) Upon transferring the captured packet to a remote unit, the processing for copying the packet from the user space to the kernel space takes place (see the region indicated by Symbol (3) in FIGS. 9 and 11).

The comparative example can be easily implemented by adjusting settings for an application program (hereinafter, simply referred to as “application”) in the user space and the firewall, and may be embodied only with application programming interfaces (APIs) in a generic OS. The comparative example is advantageous in that it can be easily implemented. Nevertheless, the comparative example has the aforementioned drawbacks (i) through (iii). Specifically, an additional processing, such as discarding packets, is required and the processing flow becomes complicated with multiple data copies between the user space and the kernel space. This may deteriorate the packet throughput.

### [2-2] Overview of Embodiment

The present embodiment includes functions described as follows, thereby overcoming the drawbacks (i) through (iii) which may be experienced by the above-described comparative example. Hereinafter, referring to FIG. 12, the overview of processing by the present embodiment will be described.

As depicted in FIG. 12, the loopback device driver 14A includes a function (determining unit 141) of determining, when a packet to be processed by the OS 11A is received in the kernel space, whether that packet to be processed (hereinafter, referred to as “subject packet”) is addressed to the local unit or to a remote unit. The loopback device driver 14A also includes a function (guiding unit 142) of guiding the subject packet, to a suitable processing in accordance with a result of the determination by the determining unit 141.

Specifically, in a case where the subject packet (first packet) is received from Process #1 in the OS 11A on the local unit (e.g., unit #1) (see Arrow A21), the determining unit 141 determines whether the first packet is addressed to the local unit or to a remote unit.

In a case where it is determined by the determining unit 141 that the first packet is addressed to the local unit, the guiding unit 142 guides (directs) the first packet to a reception processing in the OS 11A on the local unit, in other words, to the kernel 13 (see Arrows A22 and A23).

Otherwise, in a case where it is determined by the determining unit 141 that the first packet is addressed to a remote unit, the guiding unit 142 passes the first packet to the sending device driver 121 (see FIG. 2) that controls the sending device directly in the kernel space, for causing the first packet to be sent to the remote unit by the sending device. In other words, the guiding unit 142 guides (directs) the first packet to the routing processing by the sending device driver 121 (see Arrows A22 and A24).

Otherwise, in a case where the subject packet is a second packet that is addressed to the local unit and has been received from a remote unit by the remote unit receiving device driver 122, the determining unit 141 does not make any determination on the second packet. The guiding unit 142 then guides the second packet to the reception processing in the OS 11A on the local unit, in other words, to the kernel 13 (see Arrows A25 and A23). Alternatively, the second packet may be passed directly to the kernel 13 via the loopback device driver 14A, bypassing the functions as the determining unit 141 or the guiding unit 142.

As described above, as depicted in FIG. 12, subject packets are directly exchanged between the loopback device driver 14A and the sending device driver 121 or the receiving device driver 122 in the present embodiment. Accordingly, a copy of subject packets (first packet and second packet) between the kernel space and the user space is eliminated.

Further, whether a subject packet (first packet) from Process #1 is addressed to the local unit or to a remote unit is determined by the determining unit 141, and the subject packet is selectively guided to either one of the kernel 13 and the remote unit sending device driver 121. Hence, the situation where the same packet flows on both the path indicated by Arrow A23 and the path indicated by Arrow A24 is prevented. Without requiring a firewall function as that in the comparative example, it is possible to suppress that the communication between the units is ended without being established. Since no firewall function is used, any additional processing, such as packet discarding processing, is eliminated.

In addition, the determining unit 141 does not have to make any determination on packets from a remote unit, and the packet is passed to the kernel 13 through the loopback device driver 14A. Hence, any additional determination processing is eliminated.

As described above, in the present embodiment, before packets are delivered to a process in a remote unit, any processing on the packets is carried out within the kernel space where the device drivers 14A, 121, and 122 are executed, the flow of packets is simplified, unlike the comparative example. As a result, the packet throughput is significantly improved.

### [3] Operations of Each Unit in Information Processing Apparatus of Embodiment

Next, a hardware configuration and a functional configuration of each unit 11 included in the information processing apparatus 10 illustrated in FIG. 1 will be described with reference to FIG. 2. In addition, FIG. 2 is a block diagram illustrating the hardware configuration and the functional configuration.

Each unit 11 includes at least the CPU (processing unit) 11a and the memory (storage unit) 11b. In addition, in a case where the unit 11 is a virtual machine, the CPU 11a and the memory 11b are shared by the plurality of virtual machines (the units 11) on the same hypervisor. The memory 11b, for example, is a random access memory (RAM), a read only memory (ROM), a hard disk drive (HDD), a solid state drive (SSD), or the like. The memory 11b stores various types of information necessary for the processes in the units 11, for example, software relating to the OS 11A, the hypervisor, and the like described above, and an application program for realizing various functions.

As illustrated in FIG. 2, the CPU 11a of the unit 11-1 which is connected to the external network 20 functions as the internal network interface 12a, a capturing unit 15, a sending unit 16, a blocking unit 17, a converting unit 18, and the external network interface 20a by executing the application program stored in the memory 11b. Further, the CPUs 11a of the units 11-2 to 11-5 which are connected to the unit 11-1 through the internal network 12 function as the internal network interface 12a (a remote unit sending device driver 121 and a remote unit receiving device driver 122). Similarly, the CPU 11a also functions as the loopback device driver 14A (the determining unit 141 and the guiding unit 142), the converting unit 18, and the external network interface 20a. Further, the CPUs 11a of the units 11-2 to 11-5 which are connected to the unit 11-1 through the internal network 12 function in the similar manner as the unit 11-1 by executing the application program stored in the memory 11b.

As described above with reference to FIG. 1, the external network interface 20a in the unit 11-1 is connected to the external network 20 by the first address system (192.168.1.0/24) of the external network (Ethernet) 20, and conducts a communication with the terminal 40.

As described above with reference to FIG. 1, the internal network interface 12a (communication application) in each unit 11 conducts a communication between the units 11 by the address system (127.1.0.1/5) of the inter-process communication conducted by the loopback device 14. The internal network interface 12a includes a remote unit sending device driver 121 for controlling a sending device that sends packets to remote units. The internal network interface 12a further includes a remote unit receiving device driver 122 for controlling a receiving device that receives packets from remote units.

Further, the internal network interface 12a (remote unit receiving device driver 122) has a function of selecting a packet addressed to the local unit, and transferring it to the kernel 13 via the loopback device driver 14A. The internal network interface 12a (remote unit receiving device driver 122) further has a function of transferring packets that addressed to units other than the local unit, to respective remote units. The function, for example, is effectively used in a case where the plurality of units 11 of each unified storage device described above are a plurality of virtual machines established on the hypervisor. In other words, in a case where a packet addressed to the unit 11 which operates the NAS OS is received by the unit 11 which operates the SAN OS, the packet is transferred according to the function from the unit 11 which operates the SAN OS to the unit 11 which operates the NAS OS through the hypervisor.

In the present embodiment, the loopback device driver 14A that controls the loopback device 14 has a function as a determining unit 141 and a guiding unit 142.

The determining unit 141 determines, when the loopback device driver 14A receives a packet to be processed by the OS 11A in the kernel space, whether that subject packet is addressed to the local unit or to a remote unit. The guiding unit 142 then guides the subject packet to a suitable processing in accordance with a result of the determination by the determining unit 141.

Specifically, in a case where a subject packet (first packet) is received from a process in the OS 11A on the local unit, the determining unit 141 determines whether the first packet is addressed to the local unit or to a remote unit. In a case where it is determined by the determining unit 141 that the first packet is addressed to the local unit, the guiding unit 142 guides (directs) the first packet to a reception processing in the OS 11A on the local unit, in other words, to the kernel 13.

Otherwise, in a case where it is determined by the determining unit 141 that the first packet is addressed to a remote unit, the guiding unit 142 guides (directs) the first packet to the sending device driver 121 that controls the sending device, directly in the kernel space, for causing the first packet to be sent to a remote unit by the sending device. In other words, the guiding unit 142 guides (directs) the first packet to a routing processing by the sending device driver 121. The internal network interface 12a (sending device driver 121) then outputs the guided first packet to the internal network 12, for sending it to a destination unit 11 in accordance with the address system for inter-process communications by the loopback device 14.

Otherwise, in a case where the subject packet is a second packet that is addressed to the local unit and has been received from a remote unit by the receiving device driver 122 in the local unit, the determining unit 141 does not make any determination on the second packet. The guiding unit 142 then guides the second packet to a reception processing in the OS 11A on the local unit, in other words, to the kernel 13. At this time, the second packet may be passed directly to the kernel 13 via the loopback device driver 14A, bypassing the functions as the determining unit 141 or the guiding unit 142.

In the unit 11-1 connected to the external network 20, the converting unit 18 performs address conversion between the first address system of the external network 20 and the second address system of the internal network 12. The function as the converting unit 18 can be realized using a network address port translation (NAPT) mechanism. By the converting unit 18, each unit 11 in the information processing apparatus 10 becomes possible to conduct communication with an external mechanism (for example, the terminal 40) which is connected to the external network 20.

### [4] Operations of Each Unit in Information Processing Apparatus of Embodiment

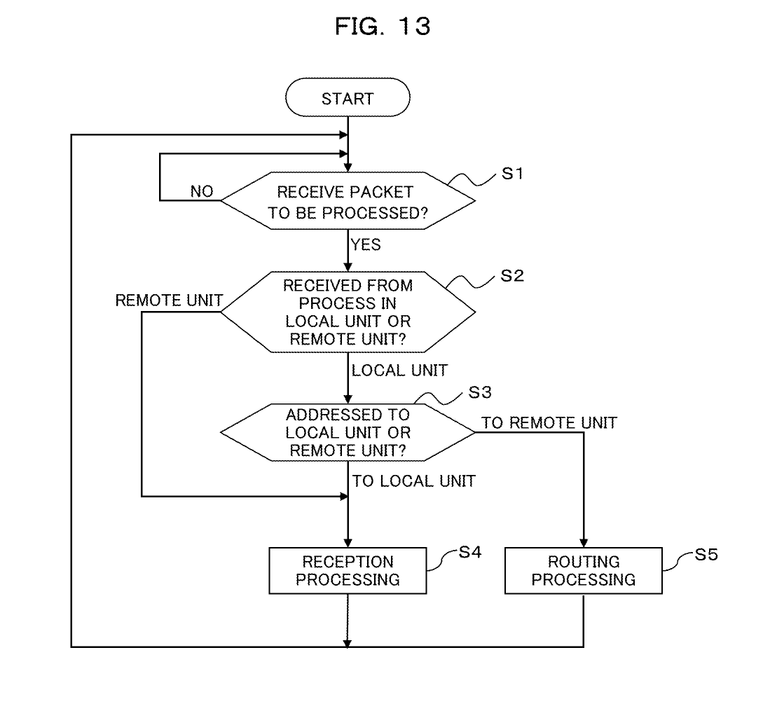

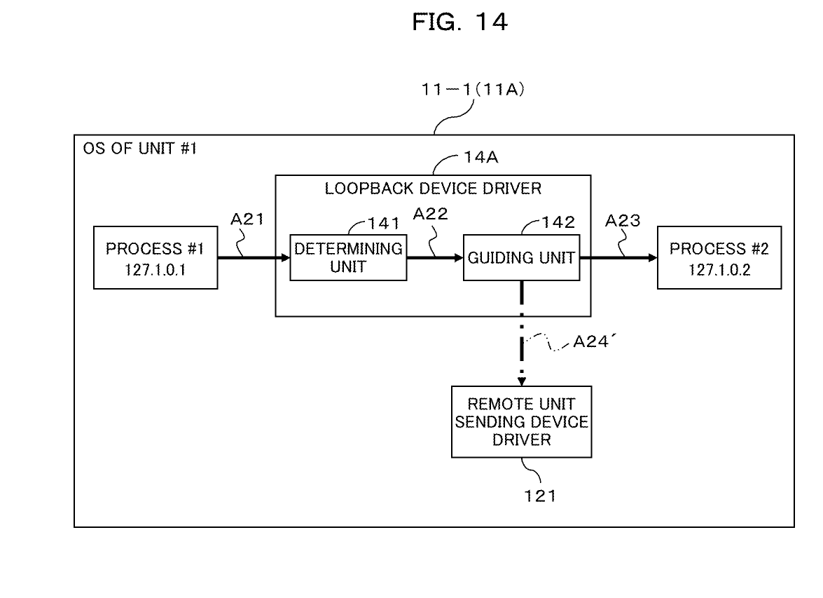

Next, the operations of the information processing system 1 which includes the information processing apparatus 10 according to the embodiment as configured above, and in particular the operations of each unit 11 will be described with reference to FIGS. 13 to 16. FIG. 13 is a flowchart for describing a procedure for communications between the units according to the embodiment (operations of the loopback device driver 14A), and FIGS. 14 to 16 are diagrams for describing the communication operation between the units according to the embodiment. In FIGS. 14 to 16, the communication operation between the unit 11-1 and the unit 11-2 is described in which only the main components in the unit 11 are illustrated. As described above, the IP addresses 127.1.0.1 and 127.1.0.2 of the address system in the inter-process communication conducted by the loopback device 14 are assigned to the units 11-1 and 11-2, respectively. In addition, in the drawings, the same symbols as those described above indicate the identical or similar portions, and thus the descriptions thereof will not be repeated.

First, the basic communication procedure between the units will be described according to a flowchart (Steps S1 to S5) illustrated in FIG. 13 with reference to FIGS. 14 to 16.

The loopback device driver 14A in the unit 11-1 determines whether a packet to be processed by the OS 11A has been receive (Step S1), and if not, it waits until a packet to be processed (subject packet) is received (NO route of Step S1).

For conducting communications between Process #1 in the unit 11-1 and Process #2 in the local unit 11-1 (see FIG. 14), Process (originating process) #1 in the originating unit 11-1 generates a packet to Process (destination process) #2 in the local unit 11-1. That packet is then outputted to the loopback device driver 14A, as a packet to be processed by the OS 11A (first packet) (see Arrow A21 in FIG. 14).

In response, the loopback device driver 14A determines that a subject packet is received (YES route of Step S1). The loopback device driver 14A then determines whether the subject packet has been received from a process in the local unit or received from a remote unit (i.e., the remote unit receiving device driver 122) (Step S2).

In this case, it is determined that the subject packet has been received from a process in the local unit (the packet is a first packet) (“LOCAL UNIT” route of Step S2). The determining unit 141 then determines whether the subject packet is addressed to the local unit or to a remote unite (Step S3). In this case, the determining unit 141 determines that the subject packet is addressed to the local unit (“TO LOCAL UNIT” route of Step S3).

In accordance with the determination result by the determining unit 141 (determination that the packet is addressed to the local unit) (see Arrow A22 in FIG. 14), the guiding unit 142 then guides the subject packet to a reception processing in the OS 14A on the local unit 11-1 (the kernel 13) (see Arrow A23 in FIG. 14). As a result, the reception processing is carried out on the subject packet (Step S4), and the flow returns to the processing in Step S1. In other words, the loopback device driver 14A continues the processing on the subject packet, and passes that subject packet to Process #2 in the local unit 11-1. In this flow, the processing of directing a packet from the guiding unit 142 to the remote unit sending device driver 121 is not carried out (see Arrow A24′ in the double dotted line in FIG. 14).

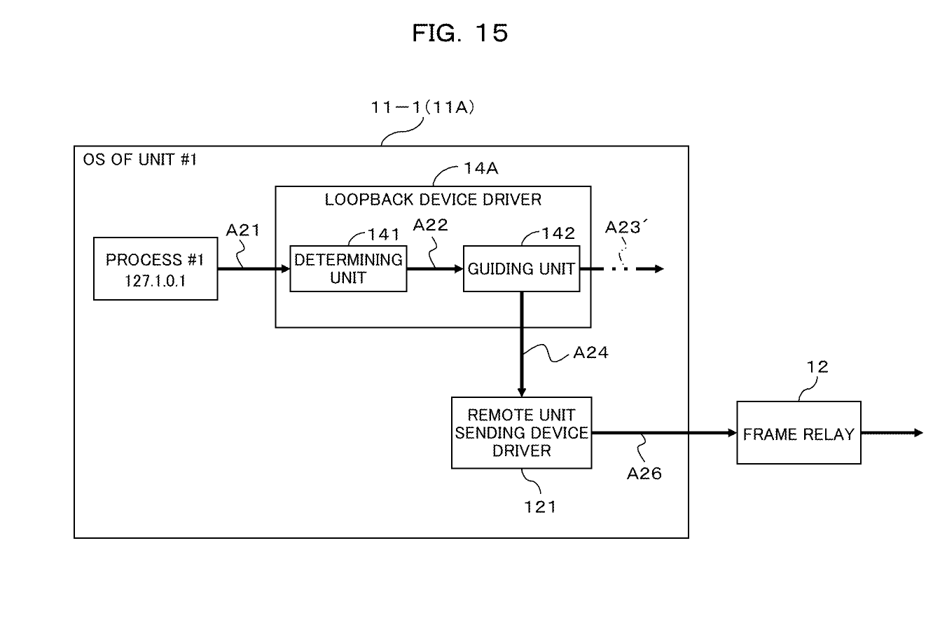

For conducting communications between Process #1 in the unit 11-1 and Process #2 in the remote unit 11-2 (see FIG. 15), Process (originating process) #1 generates a packet to Process (destination process) #2 in the remote unit 11-2. That packet is then outputted to the loopback device driver 14A (see Arrow A21 in FIG. 15), as a packet to be processed by the OS 11A (first packet).

In response, the loopback device driver 14A determines that a subject packet is received (YES route of Step S1). The loopback device driver 14A then determines whether the subject packet has been received from a process in the local unit or from a remote unit (i.e., the remote unit receiving device driver 122) (Step S2).

In this case, it is determined that the subject packet has been received from a process in the local unit (the packet is a first packet) (“LOCAL UNIT” route of Step S2). The determining unit 141 then determines whether the subject packet is addressed to the local unit or to a remote unite (Step S3). In this case, the determining unit 141 determines that the subject packet is addressed to a remote unit (“TO REMOTE UNIT” route of Step S3).

In accordance with the determination result by the determining unit 141 (determination that the packet is addressed to a remote unit) (see Arrow A22 in FIG. 15), the guiding unit 142 then guides the subject packet to a routing processing by the remote unit sending device driver 121, for causing it to be sent to the remote unit 11-2 by the sending device (see Arrow A24 in FIG. 15). As a result, the routing processing is carried out on the subject packet (Step S5), and the flow returns to the processing in Step S1. In other words, the loopback device driver 14A calls the remote unit sending device driver 121, for sending the subject packet to the remote unit 11-2 through the above-described frame relay (internal network) 12 (see Arrow A26 in FIG. 15). In this flow, the processing of directing a packet from the guiding unit 142 to the kernel 13 is not carried out (see Arrow A23′ in the double dotted line in FIG. 15). Thus, the packet discard processing using the firewall function, as the one in the comparative example, is eliminated.

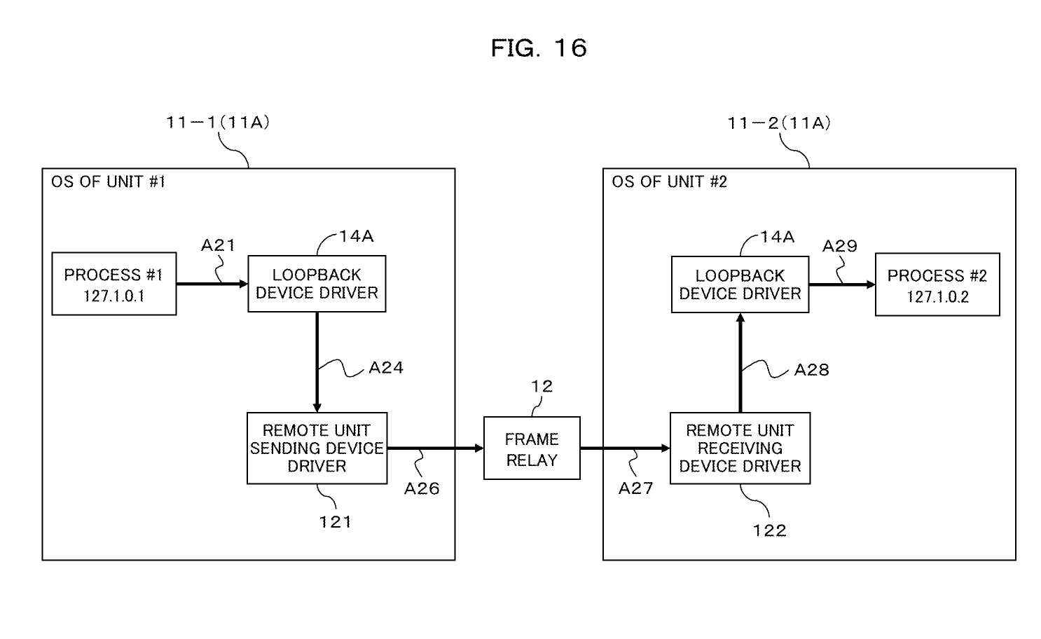

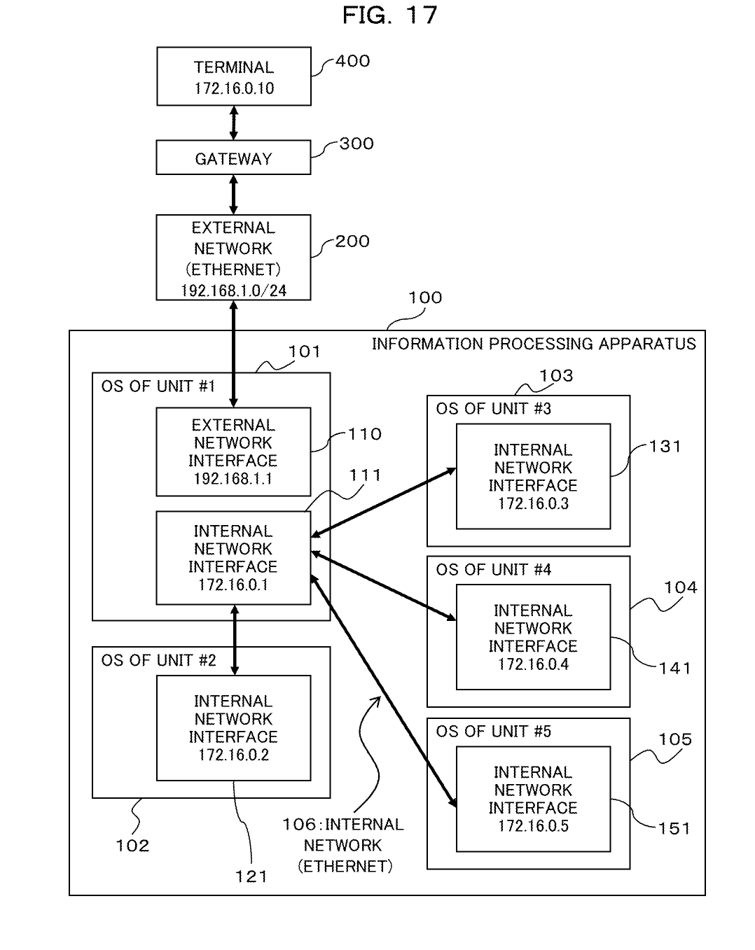

As described above, as depicted in FIG. 16, when a packet is sent to the remote unit 11-2 (see Arrow A27 in FIG. 16), that packet is received by the remote unit receiving device driver 122. The remote unit receiving device driver 122 selects the packet addressed to a local unit 11-2 from the remote unit 11-1, and passes it to the kernel 13 via the loopback device driver 14A.

In other words, the packet received at the remote unit receiving device driver 122 is outputted to the loopback device 14A, as the subject packet (second packet) (see Arrow A28 in FIG. 16).

In response, the loopback device driver 14A in the unit 11-2 determines that a subject packet is received (YES route of Step S1). The loopback device driver 14A then determines whether the subject packet has been received from a process in the local unit or from a remote unit (i.e., the remote unit receiving device driver 122) (Step S2).

In this case, it is determined that the subject packet has been received from Process #1 in the remote unit 11-1 (the packet is a second packet) (“REMOTE UNIT” route of Step S2). In this case, a determining unit 141 in the unit 11-2 (not illustrated) does not make any determination on the subject packet. A loopback device driver 14A (guiding unit 142 (not illustrated)) in the unit 11-2 then guides the subject packet to a reception processing in the OS 14A (the kernel 13) on the local unit 11-2 (see Arrow A29 in FIG. 16). As a result, the reception processing is carried out on the subject packet (Step S4), and the flow returns to the processing in Step S1. In other words, the loopback device driver 14A continues the processing on the subject packet, and passes that subject packet to Process #2 in the local unit 11-2.

While the procedure for sending packets from the unit 11-1 to the unit 11-2 has been described above, packets are also sent from the unit 11-2 to the unit 11-1 in a procedure similar to that in the above-described example. For example, a response packet P2 as depicted in FIGS. 10 and 11 is sent to Process #1 in the unit 11-1, without being passed from the loopback device 14 to the kernel 13. Communications are conducted between the unit 11-1 and the unit 11-2 in this manner.

In addition, a port number at the transmission source is automatically assigned by the OS 11A. The application program itself may designate the port number at the transmission source, but it is an exception. Since the loopback address is present in every OS, the port number at the transmission source which is assigned by the OS of Unit #1 may be the same as the port number which is automatically assigned by the OS of Unit #2. However, in the embodiment, since the port number at the transmission source is managed for every IP address, the loopback address is assigned as an address exclusively for each unit 11 (for example, 127.1.0.2 is exclusively used for the OS of Unit #2). Therefore, it is restrained that the same port number at the transmission source is redundantly assigned.

### [5] Advantages of Embodiment

According to the embodiment, using the loopback address, it is possible to establish the second address system, which is independent from the first address system of the external network 20, in the internal network 12 between the units 11 included in the information processing apparatus 10. Accordingly, the internal network 12 can be established without any influence on the external network 20.

Therefore, even when the setting of the external network 20 is changed, there is no need to change the setting of the internal network 12. Further, the internal network 12 can be established regardless of the setting of the external network 20.

Further, according to the embodiment, even in a case where an address for the internal network 12 is not possible to be secured, the address system of the internal network 12 can be established using the loopback address. The case where an address for the internal network 12 is not possible to be secured, for example, includes a case where all the private addresses are suppressed to make connection to a global space.

Furthermore, in a case where the unit 11-1 which is linked to the external network 20 is that includes the NAPT mechanism 18, the respective units 11 in the information processing apparatus 10 can conduct communication with an external mechanism (for example, the terminal 40) which is connected to the external network 20.

Further, in the present embodiment, subject packets are directly exchanged between the loopback device driver 14A and the sending device driver 121 or the receiving device driver 122. Accordingly, a copy of subject packets between the kernel space and the user space is eliminated.

Further, whether a subject packet from Process #1 is addressed to the local unit or to a remote unit is determined by the determining unit 141, and subject packet is selectively guided to either one of the kernel 13 and the remote unit sending device driver 121. Hence, without having a firewall function as that in the comparative example, it is possible to suppress that the communication between the units is ended without being established. Since no firewall function is used, any additional processing, such as packet discarding processing, is eliminated.

In addition, the determining unit 141 does not have to make any determination on packets from a remote unit, and the packet is passed to the kernel 13 through the loopback device driver 14A. Hence, any additional determination processing is eliminated.

As described above, in the present embodiment, before packets are delivered to a process in a remote unit, any processing on the packets is carried out within the kernel space (kernel layer) where the device drivers 14A, 121, and 122 are executed. Hence, additional copy processing between the kernel space and the user space is eliminated, and the flow of packets is simplified, unlike the comparative example. As a result, the packet throughput is significantly improved.

Furthermore, the internal network interface 12a has a function of transferring the other packet except the packet addressed to the local unit to the other unit while selecting and transferring the packet addressed to the local unit to the loopback device driver 14A. By the function, for example, in a case where the plurality of units 11 of each unified storage device described above are a plurality of virtual machines established on the hypervisor, it is possible to conduct communication between the units 11 which are directly connected to the units 11 through the internal network 12.

### [6] Others

Hitherto, the description has been made about preferred embodiments of the invention, but the invention is not limited to the related specific embodiments. The invention can be variously modified and changed within a scope not departing from the spirit of the invention.

Some or all of the functions as the internal network interface 12a (the remote unit sending device driver 121, the remote unit receiving device driver 122), the loopback device driver 14A (the determining unit 141, the guiding unit 142), the converting unit 18, and the external network interface 20a described above may be realized by a predetermined program executed by a computer (including a micro-processing unit (MPU), a CPU, various types of terminals).

The program, for example, may be provided in types of being recorded in a computer-readable recording medium such as a flexible disk, a CD (a CD-ROM, a CD-R, a CD-RW, and the like), a DVD (a DVD-ROM, a DVD-RAM, a DVD-R, a DVD-RW, a DVD+R, a DVD+RW, and the like), and a Blu-ray disk. In this case, the computer reads the program from the recording medium, and transfers and stores the program into an inner storage unit or an external storage unit for use.

According to the embodiment, it is possible to establish the internal network which is not affected by the external network.

All examples and conditional language recited herein are intended for the pedagogical purposes of aiding the reader in understanding the invention and the concepts contributed by the inventor to further the art, and are not to be construed limitations to such specifically recited examples and conditions, nor does the organization of such examples in the specification relate to a showing of the superiority and inferiority of the invention. Although one or more embodiments of the present inventions have been described in detail, it should be understood that the various changes, substitutions, and alterations could be made hereto without departing from the spirit and scope of the invention.

What is claimed is:

1. An information processing apparatus that is connectable to an external network, comprising:
a plurality of units, each of the plurality of units including an operating system (OS) and a loopback device that conducts an inter-process communication in the OS;
an external network interface that is provided in at least one of the plurality of units and is connected to the external network; and
an internal network interface that is provided in each of the plurality of units and is connected to an internal network which is established by a second address system independent from a first address system of the external network connected to the external network interface, wherein
an address system in the inter-process communication conducted by the loopback device is used as the second address system,
the internal network interface of each of the plurality of units conducts a communication between the plurality of units using the second address system, and
each loopback device driver comprises:
a determining unit that determines whether a packet to be processed by the OS is addressed to a local unit or to a remote unit; and
a guiding unit that guides the packet to be processed to a processing in accordance with a result of determination by the determining unit.

2. The information processing apparatus according to claim 1, wherein
in a case where the packet to be processed is a first packet from a process in the OS on the local unit, the determining unit determines whether the first packet is addressed to the local unit or to the remote unit and the guiding unit guides the first packet to the processing in accordance with the result of determination by the determining unit.

3. The information processing apparatus according to claim 2, wherein
in a case where it is determined by the determining unit the first packet is addressed to the local unit, the guiding unit guides the first packet to a reception processing in the OS on the local unit.

4. The information processing apparatus according to claim 2, wherein
in a case where it is determined by the determining unit the first packet is addressed to the remote unit, the guiding unit guides the first packet to a routing processing that is to be performed by a sending device driver that controls a sending device, for causing the first packet to be sent to the remote unit by the sending device.

5. The information processing apparatus according to claim 1, wherein
in a case where the packet to be processed is a second packet that is addressed to the local unit and is received from the remote unit by a receiving device driver in the local unit, the guiding unit guides the second packet to a reception processing in the OS on the local unit, without the determining unit making any determination on the second packet.

6. The information processing apparatus according to claim 1, wherein
the internal network is established by a general-purpose communication line which is not Internet Protocol (IP) communication or a shared memory between the plurality of units.

7. The information processing apparatus according to claim 1, wherein
the at least one of the plurality of units connected to the external network includes a converting unit which performs address conversion between the first address system of the external network and the second address system of the internal network to conduct communication between a terminal that is communicatively connected to the information processing apparatus through the external network and the plurality of units.

8. The information processing apparatus according to claim 1, wherein
the plurality of units are a plurality of virtual machines, each of which is established on a hypervisor.

9. An information processing system comprising:
an external network; and
an information processing apparatus that is connectable to the external network and is communicatively connected to a terminal through the external network, the information processing apparatus comprising:
a plurality of units, each of the plurality of units including an operating system (OS) and a loopback device that conducts an inter-process communication in the OS;
an external network interface that is provided in at least one of the plurality of units and is connected to the external network; and
an internal network interface that is provided in each of the plurality of units and is connected to an internal network which is established by a second address system independent from a first address system of the external network connected to the external network interface, wherein
an address system in the inter-process communication conducted by the loopback device is used as the second address system,
the internal network interface of each of the plurality of units conducts a communication between the plurality of units using the second address system, and
each loopback device driver comprises:
a determining unit that determines whether a packet to be processed by the OS is addressed to a local unit or to a remote unit; and
a guiding unit that guides the packet to be processed to a processing in accordance with a result of determination by the determining unit.

10. The information processing system according to claim 9, wherein
in a case where the packet to be processed is a first packet from a process in the OS on the local unit, the determining unit determines whether the first packet is addressed to the local unit or to the remote unit and the guiding unit guides the first packet to the processing in accordance with the result of determination by the determining unit.

11. The information processing system according to claim 10, wherein
in a case where it is determined by the determining unit the first packet is addressed to the local unit, the guiding unit guides the first packet to a reception processing in the OS on the local unit.

12. The information processing system according to claim 10, wherein
in a case where it is determined by the determining unit the first packet is addressed to the remote unit, the guiding unit guides the first packet to a routing processing that is to be performed by a sending device driver that controls a sending device, for causing the first packet to be sent to the remote unit by the sending device.

13. The information processing system according to claim 9, wherein
in a case where the packet to be processed is a second packet that is addressed to the local unit and is received from the remote unit by a receiving device driver in the local unit, the guiding unit guides the second packet to a reception processing in the OS on the local unit, without the determining unit making any determination on the second packet.

14. The information processing system according to claim 9, wherein
the internal network is established by a general-purpose communication line which is not Internet Protocol (IP) communication or a shared memory between the plurality of units.

15. The information processing system according to claim 9, wherein
the at least one of the plurality of units connected to the external network includes a converting unit which performs address conversion between the first address system of the external network and the second address system of the internal network to conduct communication between a terminal that is communicatively connected to the information processing apparatus through the external network and the plurality of units.

16. The information processing system according to claim 9, wherein
the plurality of units are a plurality of virtual machines, each of which is established on a hypervisor.

17. A computer-readable recording medium having stored a program, when being executed on an information processing apparatus that is connectable to an external network and comprises:
a plurality of units, each of the plurality of units including an operating system (OS) and a loopback device that conducts an inter-process communication in the OS;
an external network interface that is provided in at least one of the plurality of units and is connected to the external network; and
an internal network interface that is provided in each of the plurality of units and is connected to an internal network which is established by a second address system independent from a first address system of the external network connected to the external network interface, wherein
an address system in the inter-process communication conducted by the loopback device is used as the second address system,
the internal network interface of each of the plurality of units conducts a communication between the plurality of units using the second address system,
the program causing the OS to:
determine whether a packet to be processed by the OS is addressed to a local unit or to a remote unit; and
guide the packet to be processed to a processing in accordance with a result of determination.

18. The computer-readable recording medium according to claim 17, wherein
in a case where the packet to be processed is a first packet from a process in the OS on the local unit, the program causes the OS to determine whether the first packet is addressed to the local unit or to the remote unit and to guide the first packet to the processing in accordance with the result of determination.

19. The computer-readable recording medium according to claim 18, wherein
in a case where it is determined that the first packet is addressed to the local unit, the program causes the OS to guide the first packet to a reception processing in the OS on the local unit.

20. The computer-readable recording medium according to claim 18, wherein
in a case where it is determined that the first packet is addressed to the remote unit, the program causes the OS to guide the first packet to a routing processing that is to be performed by a sending device driver that controls a sending device, for causing the first packet to be sent to the remote unit by the sending device.
